(19) United States
(12) Patent Application Publication
(10) Pub. No.: US 2003/0101866 A1
(43) Pub. Date: Jun. 5, 2003

(54) Separation of fluid mixtures using membranized sorption bodies

(76) Inventor: Andreas Noack, Mainz (DE)

Correspondence Address: VIDAS, ARRETT & STEINKRAUS, P.A., 6109 BLUE CIRCLE DRIVE, SUITE 2000, MINNETONKA, MN, 55343-9185, US

(21) Appl. No.: 10/258,335

(22) PCT Filed: Apr. 20, 2001
(86) PCT No.: PCT/EP01/04527

(30) Foreign Application Priority Data
Apr. 20, 2000 (DE) 100 19 695.0
Apr. 20, 2000 (DE) 100 19 711.6

(51) Int. Cl. B01D 53/22

(52) U.S. Cl. 95/45; 96/4

(57) ABSTRACT

Described is a device and a method for separation of fluid mixtures, the device comprising a porous and sorptively-acting body being at least at one of its external surfaces in direct contact with a separating layer, provisions for asymmetrical heating for targeted introduction of thermal desorption energy into the porous body, as well as provisions for removing substances permeating through the separating layer, the separating layer consisting of polymers, carbon fibers, and carbon-like and/or metallic materials and/or oxidic and non-oxidic ceramic materials and/or glasses.

The present invention relates to a device and to a method for separating fluid mixtures, and to a method for increasing the performance of membranes, or gas separation systems acting like membranes.

Liquid, gaseous, and vaporous fluid mixtures can be separated on membranes. Liquid substance mixtures are separated on membranes using pertraction, one component of the fluid mixtures being retained by the membrane, and a second component of the mixture passing through the membrane. During this process the permeate is received and removed on the back of the membrane by a liquid phase.

In the so-called pervaporation, a liquid fluid mixture is brought in contact with a membrane, one substance in the mixture being retained, and a second substance permeating the membrane and evaporating on the back of the membrane in a vacuum.

The separation of vapours or gases on membranes occurs through vapour or gas permeation, a substance of the mixture again permeating the membrane, and being removed on the back of the membrane.

In all listed cases, permeation is driven by concentration gradients of the substance which permeates or which is capable of permeating through the membrane.

For separation of gaseous fluid mixtures by using porous membranes, particularly four separation mechanisms are known:

1. Separation due to different molecular masses of the components in the Knudsen diffusion through the membrane pores.

2. Separation due to a molecular sieve effect, the smaller molecules of a gas mixture being able to pass through customized pores, and larger molecules being held back.

3. Separation due to partial condensation of individual components of the gas mixture in the pores, and subsequent removal of the condensed gas components through the pore.

4. Separation due to selective adsorption of individual components of the gas mixture at the pore surface, and subsequent surface diffusion of the adsorbed molecules through the pore.

The above mentioned mechanisms differ markedly, particularly regarding the selectivity of the separation. Whereas the selectivity of mechanism 1 is generally very low, the selectivity of mechanism 2 depends on the exact adjustment of the pore size in the membrane, putting high demands on the manufacture of such molecular sieve membranes. The primary limiting factor in these mechanisms is the partial pressure of the condensation of the component to be separated, which in turn depends on the system temperature, which is the reason why the pores have to be as small as possible in the subnano range, so that the separation can only be performed under limited external conditions. Furthermore, a very homogenous pore distribution is required, which cannot be easily generated in this pore size range.

The 4th mechanism is the most flexible in terms of external separation conditions, however, it puts high demands on the composition of the membrane, the adsorption ability of which substantially determines the selectivity.

Common two-layer membrane systems known in the prior art consist of an active separating layer and a porous supporting layer. These membranes are either designed as a composite membrane or as an asymmetrical membrane.

For the composite membrane, a thin, active separating layer is brought on to a porous supporting layer, the porous supporting layer itself consisting of one or more porous layers. Asymmetrical membranes are generally porous polymer systems, which have been modified afterwards in such way, that a thin, homogenous, active separation layer is formed on one side of the membrane.

In the membrane separation methods known from the prior art, the required concentration gradient, forming the driving force for the substance transgression of the permeating component, is generated, since negative pressure or a vacuum exist on the back of the separating layer of the membrane, and/or a positive pressure is used on the condensating side of the membrane. The processing temperature in such pressure-operated membrane systems is generally as low as possible, since low temperatures generally have a positive effect on the selectivity of the separation.

Adsorption membranes have the additional disadvantage of being susceptible to particularly strong adsorbing components of the fluid mixture, which occupy the adsorption sites at the pores and block them efficiently. These strongly adsorbing components, e.g. the often unavoidably present water vapour, can only be removed with difficulties under normal, technically applicable negative pressures, which is why the degree of efficiency of such membrane systems under operating conditions decreases relatively fast. To avoid this problem, gas mixtures to be separated have to be elaborately pre-dried, or pre-cleaned.

With respect to the membrane separation methods for separation of fluid mixtures known in the prior art, there is a need for simply built, selective membrane systems, from which membrane blocking substances can easily be removed. Furthermore, there is a need for a membrane separation device working with low pressures, which is universally applicable without constructive limitations.

Membranes functioning according to the separation mechanisms of pore condensation and surface flow clog easily, since very large molecules, or difficult-to-desorb molecules, can pass through the membrane, and cannot be released from the sorbens in the desorption step. These membranes tend to “fill up” from the desorption side, finally leading to clogging of the membrane.

In view of this background, the object of the present invention is to provide a device and a method for separation of fluid mixtures, which can efficiently remove strongly adsorbing molecules from the membrane, and allowing a cost-effective separation of individual components from fluid mixtures in a technically simple manner. It is a further object of the invention to provide a device for separation of fluid mixtures, which can be used optimally for various separation tasks.

Furthermore, it is an object of the present invention to provide membrane devices allowing for good selectivity with high permeate flow, and at the same time with low susceptibility to intoxication and contamination of the membrane.

A further object of the present invention is to provide a method for simple detoxification of continuously operated separating membranes.

The solution of the above mentioned objects is obtained from the features of the independent claims. Preferred embodiments are defined in the respective subclaims.

The device-related object is solved according to the present invention by a device for separation of fluid mixtures, comprising a porous and sorptively acting body, at least one external surface of which is in direct contact with a separating layer, provisions for asymmetrical heating for targeted introduction of thermal desorption energy into the porous body, provisions for generating a pressure gradient, as well as provisions for removing substances permeating through the separating layer, the separating layer consisting of polymers, carbon fibers, and carbon-like and/or metallic materials and/or oxidic and non-oxidic ceramic materials and/or glasses.

The method-related object is solved according to the invention by a method for separation of fluid mixtures of at least two components, comprising the following steps:

a) Contacting of a separating layer with a fluid mixture to be separated in a first working area;

b) Permeating at least one component through the separating layer into a sorption body;

c) Moving at least one component of the fluid mixture to be separated through areas of the sorption body acting as sorption channels into the desorption area of the sorption body,

d) Thermically supported desorption of at least one in the desorption area present component into a second working area.

A further method-related aspect of the present invention relates to a method for increasing the selectivity and/or permeability of membranes and/or membrane-like acting gas separation systems, at least one principal component preferably and one secondary component at least partially permeating through a separating layer and/or a membrane system, and one principal component having an at least 10-fold reduced dwelling time compared to a secondary component at the selected pressure and temperature conditions, the membrane and the membrane-like acting gas separation system being heated asymmetrically in situ.

In the context of the present invention it is understood, that a first working area is the area on the retention side or feeding side of the separating layer or the membrane, respectively, and that a second working area is the area on the side of the permeate. It is preferred according to the prevention that both working areas are interconnected basically fluid-tight, so that individual fluid components need to permeate through the separating layer to move from the first to the second working area.

Asymmetrical heating of the sorption body according to the invention means, that basically only individual parts, areas, or surfaces of the sorption body are modified in their temperature, i.e. are heated or cooled. It is preferred that the asymmetrical heating leads to a temperature increase in the permeate, being at least 50% higher than the one in the retentate, preferably at least 200%, and particularly preferably at least 500%.

An important element of the present invention is the so-called sorption body. This is a porous body preferably build from a sorptively-acting material. The sorption body according to the invention is, at least at one of its external surfaces, in contact with a separating layer, allowing the selective passage of one or more components from a fluid mixture from the outside of the separating layer into the sorption body. The permeate passing through the membrane is adsorbed in the pore system of the sorption body, chemsorbed and/or absorbed. The sorption body will preferably be dimensioned in such a way that larger amounts of permeate may be taken up into the pore system and stored intermediately.

The sorptively-acting body has several functions. On the one hand, it acts as a support for the separating layer, providing sufficient mechanical stability, on the other hand, the body, through its sorption properties, causes the removal of membrane toxins from the separating layer during the operation of the fluid separation device, the toxins being removed from the separating layer by the body, and taken up and stored in its pore system.

The term “sorptively-acting” is used in the following for adsorption and absorption, as well as for all other kinds thereof, such as chemosorption, physical adsorption, etc.

Surprisingly it was observed that membrane toxins can be continuously removed during operation of the separating device by applying the membrane to a sorptively-acting supporting body, membrane toxins being substances that are sorbed or held so strongly on membranes, that they block and inactivate the membrane surface.

Furthermore, the separating body provides that substances, which may contaminate and clog the membrane, drain off the membrane separating layer into the supporting body, probably due to a surface-flow mechanisms, and are stored in its micropore system for a long time. It could be observed, that even strongly adsorbing, and substances strongly attached to the membrane can continuously migrate off into the supporting body, and that the separating layer therefore remains free of membrane toxins.

By bringing the membrane in contact with a sorptive body with high porosity and large inner surface, the substances that are basically mobile on, but difficult-to-desorb from the inner surface of the sorptive body, can quickly drain off the membrane itself. In this way it is prevented, that these species combine to some kind of condensate film on the surface, which then has a markedly reduced vapour pressure than the individual species (compare Kelvin equation). Furthermore, the large inner surface of the sorptive body increases the effective exchange surface between adsorbant and fluid phase, and by that accelerates the effective desorption rate of the difficult-to-adsorb species.

The driving force for the migrating of the membrane toxins into the porous body has thermodynamic as well as kinetic reasons. Thermodynamically, the adsorption enthalpy is higher in the micropore system of the supporting body that on the surface, or in the pores of the membrane. This is primarily related to the cage-like pores in the carrier, allowing stronger adsorption than the slot pores in the separating layer. Kinetically favoured is the migration of membrane toxins into the carrier body, since the collective adsorbate flow on the surface into the direction of the lower concentration gradient, as well as the gas flow behind the membrane, drives even molecules that are strongly adsorbed on the surface to the desorption limit.

The sorption body supports the flow-off of all permeates from the actual bottle-neck of all membrane separation methods, the membrane itself, by a downstream surface flow or capillary flow of the permeated components. It provides a large exchange surface to allow for an energetically advantageous desorption, and to avoid the condensation of permeates behind the membrane, and thus the decrease of the vapour pressure.

Furthermore, it provides a carrier for the separating layer or the membrane, preferably realising a maximal external surface in relation to the volume.

The device according to the invention may be understood in principle as a combination of conventional membrane separation methods and adsorption filters. Whereas in continuously operating conventional membrane separation methods the selectively membrane-passing permeates are removed on the permeate side by negative pressure, and therefore a separation of the substance in permeate and retentate occurs, adsorption filters filter individual components from a fluid flow, the components being sorptively kept in the pore system of the filter.

Conventional adsorption filters are exhausted when all adsorption sites are occupied, and have to be discontinuously regenerated by desorption. This regeneration is generally performed by blowing in hot steam, and subsequent drying of the adsorption material, vacuum desorption, etc.

The present invention advantageously combines the continuous separation of fluid mixtures on membranes with the simple thermic, but discontinuous desorption, which is possible with conventional adsorption filters. Thus, a continuously operating substance separating method is gained, operating without the need of desorbing permeates at high negative pressure, and avoiding disadvantages related therewith.

The device according to the invention/the method according to the invention is particularly useful for increasing the selectivity and/or the permeability of membranes and/or of membrane-like acting gas separation systems, one main component preferably and at least one secondary component at least partially permeating a separating layer and/or a membrane system, and one main component having an at least 10-fold reduced dwelling time than a secondary component at the selected pressure and temperature conditions, the membrane or the membrane-like acting gas separation system being heated asymmetrically in situ.

The device according to the invention for separation of fluid mixtures is preferably built in such way, that a sorption body with any external form is provided, preferably having on one side a separating layer, which is attached directly to the surface of the porous sorption body, or at least being in direct contact with it, the contact providing substance transgression between separating layer and sorption body. Furthermore, the device is built in such way that the outer side of the membrane separating layer, which is turned away from the sorption body, can be brought into contact with a fluid mixture to be separated, the non permeating substances being removed again as retentate from the outside of the membrane.

When the interfering or difficult-to-desorb secondary component is present in feed in a concentration between 1 ppm and 50 vol %, the device according to the invention allows for an almost interference-free separation of the main component from the fluid mixture to be separated.

The sorption body synergises especially well with membranes functioning according to the separation mechanisms of pore condensation and surface flow, since here even very large molecules can pass the membrane, which do not separate from the sorbens in the desorption step. These membranes tend to “fill up” from the desorption side, eventually leading to clogging of the membrane. Here, a critical feature is, that the difficult-to-desorb species tend to enrich at the flow-off side, which is why it is particularly useful to heat this flow-off side of the sorption body at least temporarily.

The sorption body applicable according to the invention consists of a preferred embodiment made of a material with a sufficient electrical conductivity to allow the conduction of an electrical current through the sorption body. In a particularly preferred embodiment, the sorption body consists of a material with a accordingly suitable Ohm resistance, so that during conduction of an electrical current through the sorption body the sorption body experiences an at least partial, regional and/or complete heating according to the Ohm resistance heating.

The sorption body according to this preferred embodiment is provided with suitable provisions for conducting electrical current e.g. by direct connection with positive and negative electrodes attached on opposite sides of the body, connected to a power source. Furthermore, on the not-membranized surface on the permeate side of the sorption body, provisions for removing substances that have permeated through the separating layer are envisaged. This deduction of permeate may take place by pumping at low negative pressure, transmission of a permeate or inert gas flow, or equivalent methods.

However, the sorption body may of course also be made of non-conductive material, if the heating is performed with alternative heating methods, such as infrared or microwave radiation.

A particularly preferred embodiment of the present invention comprises a sorption body provided with a membrane separating layer on almost its entire outer surface, in which the permeate is removed e.g. through bores on the inside of the sorption body. For enlargement of the membrane surface, the membranized outer surface of the sorption body may be configured preferably lamella-like.

The sorption body consists of a material, which is both, porous and with sorptive properties.

The pore sizes of sorption bodies suitable according to the invention are 10 Å to 1 mm in average.

Sorption bodies suitable according to the invention have BET-surfaces of at least 1 m²/g, preferably at least 10 m²/g, and most preferred between 250 and 2,000 m²/g. Typically, the BET-surfaces of sorption bodies according to the invention are between 750 and 2000 m²/g.

Suitable materials for sorption bodies according to the invention comprise e.g. charcoal, sintered charcoal, amorphous and/or pyrolytic carbon, ceramics such as doped silicon and aluminium oxides as applicable, zeolithes (type A, Y, ZSM5), metal-doped zeolites, conductive polymers such as polydiacetylene, polycarbazole, carbon-doped silicone elastomers, Luvocom® plastics, metal-doped polycarbonates, porous glass (quartz, Vycor®), etc. Particularly preferred are charcoal-based sorption bodies, particularly those made of sintered charcoal, or of pyrolysed paper materials.

Such charcoal-based sorption bodies can be produced relatively easily in any form from sinterable materials according to known methods for production of moulded padding.

Sorption bodies according to the invention can be used in almost any external form, for example formed as panels or tubes. Particularly preferred is the use of moulded padding made by extrusion, particularly those with lamellar structure. Production of these has long been known in the prior art (see here for carbon bodies e.g. Fuel 1881, Vol. 60, pp. 817, DE 21 19 829, DE 36 18 426). Generally, the production of moulded charcoal parts takes place by pressing of charcoal/binder mixtures, subsequent sintering and steam activation.

In a particularly preferred embodiment, sintered charcoal is used as sorption body material with a density of 0.2-1.8 kg/L, preferably 0.4-1.0 kg/L, and a BET surface larger than 100 m²/g, preferably larger than 500 m²/g, more preferably larger than 800 m²/g, particularly preferred larger than 1000 m²/g, and especially preferred larger than 1200 m/g. Such sintered charcoal materials allow a high surface mobility of adsorbed components. Furthermore, such charcoal material is particularly suitable for applying bores for flow-off channels.

In preferred embodiments of the present invention, the sorption body is prepared from a pyrolysed, paper-containing basic matrix, which is suitably folded, embossed and compacted to provide a sorption body with an as large as possible outer surface and smallest space.

Respective sorption bodies may be obtained by pyrolysis of a planar, paper-containing basic matrix, particularly a basic matrix of polymeric fiber-containing materials, with oxygen exclusion, and at increased temperature. The paper-containing basic matrix may eventually be embossed prior to pyrolysis with a groove pattern, and/or may be folded in various geometrical arrangements into compact packages. Furthermore, the obtained sorption body may be modified by chemical gas deposition of volatile ceramic precursors or hydrocarbon compounds to obtain rigid, membranized and self carrying sorption body systems with advantageous pore characteristics.

According to the invention usable and preferred sorption bodies on the basis of pyrolysed paper may be easily and cost effectively produced as follows:

In a first step, glass and carbon fiber substances are added to a suitable fiber paper, which is impregnated with aromatic resins and the like.

Particularly suitable are fiber papers consisting of natural, semisynthetic, and/or synthetic fiber substances. The fiber substances provide sufficient porosity in the densification during pyrolysis/carbonisation.

Suitable natural fiber substances comprise abaca, bamboo, hemp, cellulose, amylose, starch, polyoses, lignin, flax, hemp, jute, sisal, coco, kenaf, ramie, rosella, sunn hemp, urena, linen, cotton, kapok, and fibers from corn straw, alfa or esparto grass, fique, henequen, manila, phormium, bagasse, linters, and the like.

Suitable semisynthetic fibers are selected from sulfate cellulose, sulfite cellulose, sodium bicarbonate cellulose, cellulose derivatives, such as cellulose ester and ether, cellulose acetate, alginate, viscose, cuam rayon, polyisoprene, and the like.

Suitable synthetic fibers are selected from homo- and copolymers of polyacrylnitrile, polyvinylalcohol, polyethylene, polypropylene, polyamide, polyester, polyurethane, as well as glass fibers, glas microfibers, and the like.

In a preferred embodiment, a paper is used selected from abaca long fiber paper, teabag paper, linen paper, hand-made paper, print paper, filter paper, blotting paper, wood-free paper, wood-containing paper, kraft paper, crepe paper, board paper, cardboard, LWC paper, oil paper, overlay paper, packing paper, recycling paper, synthetic fiber paper, tissue, and the like.

Particularly suited are papers with a volume-related surface of at least 1,000 m²/m³, preferably 10,000 m²/m³, and especially preferred 20,000 m²/m³. Especially preferred is linen paper with a grammage of about 20 g/m², or also abaca long fiber paper with a grammage of about 12 g/m².

By screen printing or other methods, a mixture of silicon oxide and aromatic resin may subsequently be applied to the glass fiber side in a thin layer, e.g. with a strength of several μm, in the form of grooves or line patterns. The so pre-treated paper is then embossed to form a structure with groove-like indentations serving later as flow channels in the sorption body. Furthermore it may be advantageous to overlay the paper with wave embossing, with which potential shrinkage during the heat treatment process may eventually be compensated.

In order to direct permeate and/or feed flow during operation of a sensor according to the invention, and to optimise their flow profile, it is preferred according to the invention to provide a groove structure in the form of parallel grooves. By subsequent folding of the paper defined flow-off channels are derived, which allow an optimal flow turbulence on the feed side of the membrane as well as a fast substance exchange on the permeate side. However, any other surface structures e.g. indentations, nubs, and the like, selected by a person skilled in the art, can be applied depending on the form of the material to be pyrolysed, and on the specific application of the membrane.

Particularly preferred according to the invention is the embossment of diagonal grooves with a distance of about 100 nm on the paper, optionally one-sided or two-sided on the paper sheet. Particularly preferred is a structural embossment on the permeate side, which may be generated by the use of embossing techniques, e.g. roller pressing, known to a person skilled in the art.

Two of these papers, or paper sheets, are then brought on top of each other, so that the embossing or the diagonally embossed grooves lie on top of each other in an angle, preferably in a right angle, and are finally folded to a package, especially into a double folded package. A folding package, which is particularly suited according to the invention, preferably has several hundred folds.

Such a folding package is transferred to an oven, and is suctioned completely with a suitable device, e.g. a pump, and a negative pressure is loaded.

In a first temperature treatment step, the double folding package is brought to an increased temperature, e.g. to 100 to 250° C., under inert gas, e.g. N₂, argon or the like, generally for 0.5 to 3 hours depending on the size of the folding package. During this process, the aromatic resins cure, and at each front the upper and lower folding contract until a relative negative pressure of 50 to 500 mbar, preferably about 200 mbar, is achieved.

In a second temperature treatment, the double folding package is carbonized between 250° C. and 800° C. under inert gas, preferably with the carbonising gases being continuously suctioned. This will take around 2 to 8 hours, depending on the size of the folding package.

Then, in a third temperature treatment step, the double folding package is tempered at around 1,000° C. to 2,000° C. Hereby, silicon carbides and mixtures of silicon oxides and carbides form at the sites that were previously coated with silicon oxide, which, among other things, provide sufficient mechanical stability and chemical inertness of the finished component.

In a fourth temperature treatment step at about 500 to 1,800° C., the tempered double folding package is pre-membranized, or sealed, to yield a sorption body applicable according to the invention.

Sorption bodies according to the invention are provided on at least one outer surface with a suitable separating layer. In the most preferred case, the sorption body is a membrane itself. Suitable separating layers comprise polymer membranes, such as PTFE, polyacrylnitrile copolymer membranes, cellulose and cellulose derivatives such as e.g. cellulose acetate, cellulose butyrate, cellulose nitrate, viscose, polyetherimide, poly (octyl methyl silane), polyvinylidenchloride, polyamide, polyurea, polyfurane, polycarbonate, polyethylene, polypropylene, polysulfones, polyacrylnitrile, polymethylmethacrylate, ethylvinylalcohol, polydimethylsiloxane, polystyrene, polyvinylchloride, polyvinylfluoride, poly(ethylenterephthalate), polyimide, polycaprolactam, as well as co-polymerisates of various polymers.

Furthermore, suitable separating layers on sorption bodies according to the invention may comprise ceramic membranes, e.g. made of glass, silicon dioxide, silicates, aluminium oxide, perowskite, boron nitride, aluminosilicate, zeolites, titanium oxides, zirconium oxides, boron silicates, combinations of the aforementioned and the like.

The use of metallic membranes on the basis of transition metals such as Pd, Pt, Cu, Ni, Co, Mn, Cr, Fe, Au, and/or Ag, and mixtures/alloys and the like is also practicable according to the invention.

Also, the use of carbon fiber membranes, carbon nanotubules with one or more walls, carbon molecular sieve, particularly also CDV-deposited charcoal as separating layer is possible, and is particularly preferred in special embodiments of the present invention.

To generate carbon membranes on moulded paddings or sorption bodies, so-called CVD-methods are particularly useful. For these, a carrier, in the case of the present invention the sorption body folding package, is treated with hydrocarbon-eliminating composites at high temperatures (compare G. Savage, “Carbon-Carbon Composites”, Chapman & Hall, London, 1993, pp 85 ff., U.S. Pat. No. 3,960,769, and U.S. Pat. No. 3,979,330).

As hydrocarbon-eliminating composites, almost all known saturated and unsaturated hydrocarbons with sufficient volatility may be used. Examples are methane, ethane, ethylene, acetylene, linear and branched alkanes, alkenes and alkynes with carbon numbers of C₁₋₂₀, aromatic hydrocarbons such as benzene, naphthalene, etc., aromatics being substituted once or more than once with polyalkyl, alkenyl, and alkinyl residues, such as toluene, xylene, cresol, styrene, and the like. In the CVD-method these are used mostly in low concentrations in an inert gas such as nitrogen, argon and the like. Also possible is the addition of hydrogen and/or vapour to respective depositing gas mixtures.

For a equal distribution of the deposited charcoal membrane on the sorption body, a variation of the CVD method, the so-called CVI method (chemical vapour infiltration), is used, which is described in the literature and well known to a person skilled in the art (see also e.g. W. Benzinger et al., Carbon 1996, 34, page 1465). Here, the decomposed gases of the hydrocarbon-eliminating composites are suctioned to the surface of the sorption body during the deposition of the membrane by using a continuous vacuum, the carbon selectively depositing on the surface of the sorption body (“forced-flow-CVI”). Thus, a substantially more homogenous pore system in the charcoal membrane is achieved. Furthermore, homogenisation of the pore system using forced-flow-CVI increases the mechanic stability of the membrane. Optionally, a further sintering step at temperatures up to 2,000° C. may be performed after the CVI membranisation to further stabilise the homogenisation and stability. For CVI processes, substantially the same above mentioned hydrocarbon-eliminating composites are used as in the CVD method.

Also, the pore system may be subsequently expanded in case of a too low permeability of the resulting carbon membrane, by wetting the membrane for a short period of time with an oxidant, such as nitric acid, and subsequent thermal post-treatment.

Particularly preferred is a mixture of volatile hydrocarbons, preferably aromatic hydrocarbons, especially benzene, and hydrogen being blown into the folding package with slight positive pressure, and a gas mixture of inert gas, preferably nitrogen, and hydrogen being blown in at the front, which flows through the flow channels between the upper folding and the lower folding. In the area where both gas mixtures meet, mainly carbon is deposited, sealing and therefore pre-membranising the folding rows.

The strength of the resulting carbon membrane layer in sorption bodies usable according to the invention, is up to 2 mm, preferably up to 100 μm, particularly preferred up to 100 μm.

In preferred embodiments, catalytically active metals may be integrated in the carbon membrane as well, particularly noble metals such as ruthenium, osmium, rhodium, iridium, palladium, platinum, silver, gold, and/or iron, cobalt, nickel, and copper, to increase separation selectivity of the membrane.

Then, in the above mentioned preferred embodiment of a sorption body on paper base, in an optional fifth and last temperature treatment step, an electrical current is applied to the upper and lower folding of the folding package at about 500 to 900° C. Subsequently, nitrogen is blown in at the surfaces, at the front nitrogen with 10% hydrogen is blown in. At the remaining conducting contact sites between upper and lower folding, a short-circuit current occurs, heating this contact site to temperatures, at which carbon is oxidised by water vapour, and therefore is degraded to gaseous CO and/or CO₂. In the mechanic contact site between upper and lower folding substantially only SiO₂, glass, or SiC is left, mechanically and chemically stabilising the component.

Subsequently, the finished sorption body, membranized with a carbon membrane, is allowed to cool.

According to a particularly preferred embodiment, the membranized sorption body as described above is formed as a membrane package from pyrolysed paper-like basic substances. A person skilled in the art will be aware, that almost any other geometry or form of the sorption body will be applicable according to the invention. Particularly preferred, however, is the folded membrane package, since it provides the largest possible membrane surface in the smallest possible space.

Preferably, the device according to the invention is built from embossed folding structure, the folding density being between 1 and 1,000 folds per cm, preferably between 10 and 100 folds per cm. Furthermore preferred are embossed flow channels with a minimal distance in the membrane level of between 1 μm and 5 cm, preferably between 100 μm and 5 mm.

The membrane package is manufactured by multiple folding of a fiber-containing paper matrix to a compact folding package, subsequent pyrolysis under oxygen exclusion, and membranisation using CVD-deposited carbon as described above.

Particularly preferred as a sorption body is a root structure generated from an embossed and folded planar structure.

Instead of CVD-carbon membranes, also carbon fiber membranes may be used according to the invention. Carbon fiber membranes may e.g. be manufactured simply by pyrolysis of cellulose hollow fibers according to the method by Soffer et al. (U.S. Pat. No. 5,925,591). Here, a cellulose fiber layer is applied to a porous sorption body, and eventually heated to pyrolysis after a drying step, and Lewis acids or volatile salts acting as carbonising catalysts are added at some time points during catalysis.

Using module hollow fiber membrane modules it is preferred, that these are asymmetrically heated as well according to the invention.

In certain embodiments, the combination of carbon and charcoal membranes with metal membranes, polymer membranes, and/or oxidising ceramic membranes may be provided according to the invention.

An example for the combination of charcoal with metal membranes is the reaction of methanol with hydrogen, the device according to the invention using a palladium-coated sorption body made of charcoal, and the formed H₂ permeating through the Pd/carbon membrane.

In case of a too-low permeability of the resulting membrane, the pore system may be expanded afterwards, by wetting the membrane for a short time with an oxidant, e.g. HNO₃, and subsequent thermal post-treatment.

The pore sizes of membrane applicable according to the invention vary in wide areas. It is possible according to the invention to provide the sorption body with a carbon molecular sieve membrane separating certain components of the fluid mixture due to their different mobilities. The pore sizes of such carbon molecular sieve membranes relate to these, e.g. for separation of gases generally up to a diameter of 7 Å. For separations according to the mechanisms of partial condensation of individual components, the pores of respective membranes applicable according to the invention may be in the mentioned area of microporosity, i.e. with diameters of <20 Å. Particularly preferred are membranes with an average pore size of 3 to 20 Å, especially preferred of 3 to 7 Å.

The method according to the invention for separation of fluid mixtures using the sorption body device takes place in such way, that the fluid mixture to be separated is applied to the outside of the separating layer, and individual components of the fluid mixture permeate through the separating layer into the porous sorption body. There, the permeates are sorbed (adsorbed, chemosorbed and/or absorbed) in the pore system, and are distributed by surface flow, due to site exchanging processes of sorbed species, diffusion and/or similar transportation processes in the pore system of the sorption body.

It is preferred according to the invention, that components reducing the permeability of the separating layer flow into the sorption body by direct contact of the separating layer and the sorption body with the purpose of in situ regeneration of the separating layer, and subsequently are transported to a desorption area of the sorption body at which components desorb with thermal support.

The heating of parts of the sorption body with suitable devices for introduction of energy may take place also by electrical heating conductors, infrared radiators, induction heating, microwave heating, UV radiators, halogen rod heating, and/or passing hot fluid flows through the sorption body.

The devices used according to the invention for introduction of energy may comprise catalysts arranged advantageously at the desorption side allowing the oxidation of permeating organic substances, the catalysts comprising Pd, Cu, Ag, Pt or Ni, eventually on porous ceramic carriers.

The method according to the invention may be conducted in such way, that the temperature in the second working area is selected to be lower than, equal to, or higher than in the first working area.

Also, the introduction of chemical energy into the sorption body in form of reaction heat is realized in certain embodiments of the invention, if the reaction heat of the catalytic oxidation of organic permeates on catalysts, introduced into the sorption body, is to be used for desorption of products. Suitable catalysts are e.g. Pd, Ag, Cu, Pt and Ni, eventually on porous ceramic carriers inside or outside of the sorption body.

Generally spoken, the device and the method according to the invention are characterized by providing means for generation and/or enhancement of a concentration gradient from the first to the second working area in at least one of the working areas relating to at least one permeating components, these means being selected from cooling or heating devices, means for generation of negative or positive pressure, electrical potentials, and the like.

Preferably, the method according to the invention is performed with a pressure gradient decreasing from the first to the second working area.

Generally, the sorption body is located on the permeate side of the separating layer. In an alternative embodiment, the means for generation of a concentration gradient comprise suitable cooling devices on the permeate side of the separating layer, providing a continuous freezing/condensation of the permeate.

In addition or alternatively to cooling and heating devices on the permeate side of membrane devices according to the invention the application of negative pressure on the permeate side is applicable advantageously for generation or enhancement of a concentration gradient. Particularly for separation of gas mixtures, the application of positive pressure on the retentate side (first working area) of membrane devices according to the invention is suitable for generation of a concentration gradient increasing the permeate flow. Also the combination of positive pressure on the retentate side and negative pressure on the permeate side of the membrane, if applicable in combination with heating or cooling devices on the permeate side, is applicable advantageously in preferred embodiments of the present invention.

For separation of ionic or electrically conducting fluid mixture, the application of an electrical potential gradient at the separating layer is particularly advantageous to generate a concentration gradient. For this, an electrical potential gradient may be generated by respective arrangement of electrodes in both working areas of the membrane device, which is controllable by suitable controlling devices, so that the permeate flow as well as the membrane selectivity may be controlled respectively.

Devices according to the invention reach carbon tetrachloride loads between 10 and 90 weight %, benzene loads of at least 3 weight % after application of 3.2 g/m², as well as iodine loads of at least 1 mg/g, preferably of at least 75 mg/g, depending on material combination.

Generally, fluid separation according to the invention may take place at a temperature ranging from minus 200° C. to plus 1,000° C., the temperature to be selected depending individually from the selected device and the separation task to be solved, and fluctuating in wide areas.

Depending on the kind of separation, the actual device, and the components to be desorbed, the temperature required for desorption in sorption bodies according to the invention is between −200 and 300° C., preferably between 0 and 150° C. for gas separation, pervaporation, and vapour permeation. In individual cases it can be heated to higher temperatures, to 500° C. or more, especially in the case of ceramic sorption bodies. For separations in the condensed phase, generally temperatures in the range of 20 and 150° C. are preferred. A person skilled in the art will acquire and determine by simple experiments the suitable temperature for the respective separation method by suitable devices.

For separation of oxygen-nitrogen mixtures on perowskite membranes, operating temperatures of up to 800° C. or more may be used.

The device according to the invention as well as the method according to the invention may be adjusted to various separation tasks. With the device according to the invention, the general separation of gas mixtures into individual components, such as oxygen extraction from air, hydrogen extraction from processing gases, separation of CO₂ from natural gas, separation of methane and/or CO₂ from hydrogen, and the like, may be achieved in a simple and cost-effective manner, without being dependent on application of strong negative pressure or pressure exchange methods.

For separation of oxygen-nitrogen mixtures on devices according to the invention, oxygen may be enriched to 80 weight % depending on the kind of used membrane, in the case of high temperature perowskite membranes even up to 99 weight %, with oxygen permeating.

Also, separation of hydrogen from hydrogen-containing hydrocarbon mixtures, as well as CO₂ from natural gas, are typical applications of devices according to the invention, hydrocarbons, and CO₂, respectively, being enriched as permeates.

Also, by selection of suitable materials for the sorption body and the membrane, the device according to the invention may be used for separation of fluid mixtures in pertractive methods, or in pervaporation processes, as well as in vapour permeation, dehumidification and/or decontamination of air and gases, filtration of supply or exhaust air, etc.

The particular advantage of devices according to the invention in filtration applications is, that here particle filtration is combined with molecular adsorption. This enables filtration processes even at very high pressure (100 bar). The inner heating of the filter allows sterilization as well as in situ regeneration of the adsorbent.

Also, the permeate may be suctioned continuously, and the regeneration may take place discontinuously in case of very low filtration demands. Here, the sorption body acts as an intermediate storage or reservoir for sorbed substances.

The removal of retentate from the first working area after a certain contact time, and of the permeate from the second working area may preferably take place in separate ways. For further increase of the enrichment or depletion level, fluid mixtures may be brought in contact with further devices according to the invention, in the sense of a serial connection of the membranes. Hereby, the already extracted retentate may be used e.g. as circuit gas for removal of further retentate in the first working area of a downstream and/or parallel membrane device, by e.g. being circulated. Similarly, permeate obtained from the second working area may be used for removal of desorbed components from the second working area of a downstream and/or parallel membrane device. Also, parallel fluid flow conduction on a plurality of devices according to the invention with intermediary cooling devices is envisaged. By parallel and/or serial connections of several devices according to the invention, such ultra pure permeates, or retentates, respectively, may be extracted from fluid mixtures in condensed or non condensed phase.

For oxygen-nitrogen separations, a device according to the invention may be operated advantageously with a downstream pressure swing adsorption system with zeolite membrane (zeolite PSA technology), to obtain particularly enriched permeates already at low temperatures. Also, a downstream connection of a perowskite membrane device may be provided for further enrichment of oxygen in such separations.

1. A device for separating fluid mixtures, comprising a porous and sorptively-acting body, at least one external surface of which is in direct contact with a separating layer, provisions for asymmetrical heating for targeted introduction of thermal desorption energy into the porous body, provisions for generating a pressure gradient, as well as provisions for removing substances permeating through the separating layer, the separating layer consisting of polymers, carbon fibers, and carbon-like and/or metallic materials and/or oxidic and non-oxidic ceramic materials and/or glasses.

2. The device according to claim 1,
characterized by the porous body consisting of charcoal, sintered charcoal, amorphous and/or pyrolytic carbon, carbon fibers, conductive ceramics, doped and undoped silicon and aluminium oxides, SiC, zeolites, metal-doped zeolites, conductive polymers, polydiacetylene, polycarbazole, carbon-doped silicone elastomers, Luvocom® plastics, metal-doped polycarbonates, porous glass, glass fibers, porous titanium oxide, zirconium oxide, and the like, as well as mixtures thereof.

3. The device according to any of the previous claims, characterized by the porous body having a BET-surface of at least 1 m²/g, preferably at least 10 m²/g, more preferred at least 50 m²/g and particularly preferred between 250 and 2000 m²/g.

4. The device according to any of the previous claims,
characterized by the separating layer comprising a polymer membrane selected from of the group consisting of PTFE, polyacrylnitrile copolymer, cellulose, cellulose acetate, cellulose butyrate, cellulose nitrate, viscose, polyetherimide, poly(octyl methyl silane), polyvinylidenchloride, polyamide, polyurea, polyfurane, polycarbonate, polyethylene, polypropylene, and/or copolymerisates thereof.

5. The device according to any of the previous claims,
characterized by the separating layer consisting of carbon fibers, charcoal, pyrolytic carbon, carbon nanotubules with one or more walls, carbon molecular sieve, and particularly of CDV-deposited charcoal.

6. The device according to claim 5, characterized by the average pore diameter of the separating layer being between about 3 Å and 7 Å.

7. The device according to any of the previous claims,
characterized by the separating layer comprising metallic membranes made of transition metals such as Pd, Pt, Cu, Ni, Co, Mn, Cr, Fe, Au, and/or Ag and mixtures/alloys thereof.

8. The device according to any of the previous claims,
characterized by the separating layer comprising a ceramic membrane selected from a group consisting of glass, silica, silicates, aluminium oxides, aluminium silicates, zeolithes, titanium oxides, zirconium oxides, boron nitrides, boron silicates, SiC, titanium nitrides, combinations of the aforementioned and the like.

9. The device according to any of the previous claims,
characterized by the separating layer comprising carbon or charcoal in combination with polymer membranes, metallic membranes, or oxidic or non-oxidic ceramics.

10. The device according to any of the previous claims,
characterized by the separating layer comprising carbon, or charcoal impregnated with transition metals, preferably Fe, Ni, Co containing transition metals, selectively absorbing and permeating oxygen, nitrogen, or carbon monoxide, or hydrogen.

11. The device according to any of the previous claims,
characterized by the desorption energy being introduced as thermal, electrical and/or radiation energy into the porous body.

12. The device according to any of the previous claims,
characterized by the devices for introducing energy comprising electrical heat conductors, electrodes for power supply of conductive porous bodies, infrared radiators, induction heating, microwave heating, UV radiators, and/or devices for passing hot fluid flows.

13. The device according to any of the previous claims,
characterized by the devices for introducing energy comprise catalysts being arranged on the desorption side, allowing oxidation of permeating organic substances, the catalysts comprising Pd, Cu, Ag, Pt, or Ni, if applicable, on porous ceramic carriers.

14. The device according to any of the previous claims,
characterized by the asymmetrical heating leading to a temperature increase in the permeate, which is at least 50% higher than in the retentate.

15. The device according to any of the previous claims,
characterized by the device being built from an embossed folded structure, the fold density being between 1 and 1000 folds per cm, preferably between 10 and 100 folds per cm.

16. The device according to any of the previous claims,
characterized by the device containing embossed flow channels with a minimal distance in the membrane level between 1 μm and 5 cm, preferably between 100 μm and 5 mm.

17. The device according to any of the previous claims,
characterized by using a root structure as sorption body, generated by an accordingly embossed and folded planar structure.

18. The device according to any of the previous claims,
characterized by porous, sorptively-acting body being a membrane itself.

19. A method for separation of fluid mixtures with at least two components, comprising the following steps:
a) Contacting of a separating layer with a fluid mixture to be separated in a first working area;
b) Permeating at least one component through the separating layer into a sorption body;
c) Moving at least one component of the fluid mixture to be separated through areas of the sorption body acting as sorption channels into the desorption area of the sorption body,
d) Thermally supported desorption of at least one, in the desorption area present component into a second working area.

20. The method for increasing the selectivity and/or the permeability of membranes and/or of membrane-like acting gas separation systems, preferably one main component, and at least one secondary component at least partially permeating a separating layer and/or a membrane system, and one main component having an at least 10-fold reduced dwelling time than a secondary component at the selected pressure and temperature conditions, the membrane or the membrane-like acting gas separation system being heated asymmetrically in situ.

21. The method according to claim 20,
characterized by the secondary component being present in feed in a concentration between 1 ppm and 50 vol %.

22. The method according to claims 19 to 21,
characterized by the components, that decrease the permeability of the separating layer, draining-off into a sorption body by direct contact of the separating layer with a sorption body with the purpose of in situ regeneration, and subsequently being transported into a desorption area of the sorption body, at which components desorb with thermic support.

23. The method according to claims 19 to 22,
characterized by the sorption body being porous and having adsorptive, chemosorptive and/or absorptive properties.

24. The method according to claims 19 to 23,
characterized by the movement of sorbed fluid components in the sorption body substantially taking place by exchange of location of sorbed species, surface flow of sorbates, and the like.

25. The method according to claims 19 to 24,
characterized by in at least one working area means for generation and/or enhancement of a concentration gradient related to at least one permeating component from the first to the second working area being provided, these means being selected from cooling or heating devices, means for generation of negative or positive pressure, electric potentials, and the like.

26. The method according to claims 19 to 25,
characterized by the separating layer comprising a polymer membrane, a ceramic membrane, a metallic membrane, a carbon membrane, and/or a charcoal fiber membrane.

27. The method according to claims 19 to 26,
characterized by the sorption body consisting of a material selected from carbon, charcoal, ceramic, silicium oxide, aluminium oxide, zeolite, aluminosilicate, titanium oxide, zirconium oxide, boron silicate, porous glass, boron nitride, and mixtures of these.

28. The method according to claims 19 to 27,
characterized by the temperature in the second working area being selected lower than, equal to, or higher than in the first working area.

29. The method according to claims 19 to 28,
characterized by a medium temperature increase in the permeate taking place during the heating phase being at least 50% higher than in the retentate, preferably at least 200% higher, and particularly preferred at least 500% higher.

30. The method according to claims 19 to 29,
characterized by an applied pressure gradient decreasing from the first to the second working area.

31. The method according to claims 19 to 30,
characterized by the fluid separation taking place in a temperature range between minus 200° C. and plus 1,000° C.

32. The method according to claims 19 to 31,
characterized by hollow carbon fiber membrane modules being heated asymmetrically.

33. Use of the device and/or the method according to any of the previous claims
for vapour permeation, pervaporation, dehumidification, and/or the sterilisation of air and gases, supply and exhaust air filtration, and the like.

34. Use of the device and/or the method according to any of the previous claims
as a membrane reactor, particularly for the reaction of methanol with water vapour, the formed H₂ permeating through the membrane.

35. Use of the device and/or the method according to any of the previous claims
in the general gas separation, as e.g. the separation of CO? from natural gas, the separation of methane and/or carbon dioxide from hydrogen, as well as the separation of oxygen from oxygen-nitrogen-mixtures, particularly in presence of air humidity, the oxygen being enriched in the permeate.

36. Use of the device and/or the method according to any of the previous claims
for separation of hydrogen from hydrogen-containing hydrocarbon mixtures, the hydrogen being obtained as permeate or retentate.
